(19) United States
(12) Patent Application Publication
(10) Pub. No.: US 2015/0099630 A1
(43) Pub. Date: Apr. 9, 2015

(54) METHOD OF CONTROLLING PESTS

(71) Applicant: SUMITOMO CHEMICAL COMPANY, LIMITED, Tokyo (JP)

(72) Inventor: Hajime IKEDA, Kasai-shi (JP)

(73) Assignee: SUMITOMO CHEMICAL COMPANY, LIMITED, Tokyo (JP)

(21) Appl. No.: 14/048,779

(22) Filed: Oct. 8, 2013

(51) Int. Cl. A01N 43/84; A01N 43/653; A01N 43/54

(52) U.S. Cl. CPC A01N 43/84; A01N 43/54; A01N 43/653
USPC 504/128; 504/225; 504/130; 504/243; 504/136; 504/273; 504/139

(57) ABSTRACT

The present invention relates to a method of controlling pests such as weeds in a field of crop such as wheat, tomato, egg and bell pepper.

According to the present invention, pests in such fields can be efficiently controlled.

### BACKGROUND OF THE INVENTION

1. Field of the Invention

The present invention relates to a pest control method, that is, a method of controlling pests such as harmful arthropod pests, nematodes, plant pathogens, and/or weeds.

2. Description of the Related Art

Various compounds are known as effective components for insecticides, nematicides, or fungicides. Also, protoporphyrinogen IX oxidase (hereinafter abbreviated as PPO) inhibiting compounds are known as effective components for herbicides.

### PRIOR ART DOCUMENTS

### Patent Documents

Patent Document 1: WO 95/027693
Patent Document 2: WO 06/062978
Patent Document 3: WO 08/072783

### Non-Patent Documents

Non-patent Document 1: Crop Protection Handbook, vol. 98 (2012) Meister Publishing Company, ISBN: 1-892829-25-8)
Non-patent Document 2: Compendium of Pesticide Common Names (http://www.alanwood.net/pesticides/)

### SUMMARY OF THE INVENTION

It is an object of the present invention to provide a method for producing an excellent effect on pest control in crop fields.

The present invention relates to a method of controlling pests grown in a crop field by treating the crop field with one or more PPO-inhibiting compounds before sowing or planting, at the same time of sowing or planting, or after sowing or planting crop seeds or vegetative organs such as tubers, bulbs, or stem fragments which are treated with one or more specific insecticidal compounds, nematicidal compounds, or fungicidal compounds.

The present invention is as follows.

[1] A method of controlling weeds in a crop field, the method comprising treating the crop field with one or more PPO-inhibiting compounds selected from flumioxazin, sulfentrazone, saflufenacil, oxyfluorfen and fomesafen-sodium, before sowing or planting, at the same time of sowing or planting, or after sowing or planting crop seeds or vegetative organs such as tubers, bulbs, or stem fragments which are treated with one or more compounds selected from the compound group A:

Compound group A: neonicotinoid compounds, diamide compounds, carbamate compounds, organic phosphorous compounds, biological nematicidal compounds, other insecticidal compounds and nematicidal compounds, azole compounds, strobilurin compounds, metalaxyl compounds, SDHI compounds, and other fungicidal compounds and plant growth regulators.

[2] A method of controlling pests in a crop field, the method comprising the steps of:

treating crop seeds or vegetative organs such as tubers, bulbs, or stem fragments with one or more compounds selected from the compound group A:

Compound group A: neonicotinoid compounds, diamide compounds, carbamate compounds, organic phosphorous compounds, biological nematicidal compounds, other insecticidal compounds and nematicidal compounds, azole compounds, strobilurin compounds, metalaxyl compounds, SDHI compounds, and other fungicidal compounds and plant growth regulators; and

treating the crop field with one or more PPO-inhibiting compounds selected from flumioxazin, sulfentrazone, saflufenacil, oxyfluorfen and fomesafen-sodium, before sowing or planting, at the same time of sowing or planting, or after sowing or planting the crop seeds or vegetative organs such as tubers, bulbs, or stem fragments which are treated with the compounds of the compound group A.

[3] The control method according to [2], wherein the pests are weeds.

[4] The control method according to anyone of [1] to [3], wherein one or more compounds selected from the compound group A is one or more compounds selected from the compound group A-1.

### Compound Group A-1:

neonicotinoid compounds: clothianidin, thiamethoxam, imidacloprid, dinotefuran, nitenpyram, acetamiprid, and thiacloprid;

diamide compounds: flubendiamide, chlorantraniliprole, cyantraniliprole, and a compound represented by the formula (I):

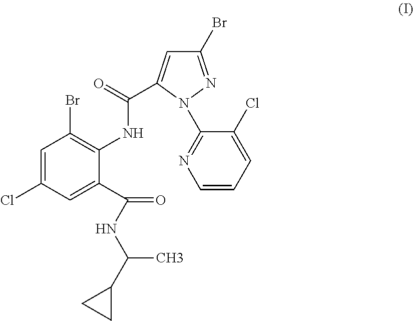 [SMILES: CC(NC(=O)c1cc(Cl)cc(Br)c1NC(=O)c1cc(Br)nn1-c1ncccc1Cl)C1CC1]

carbamate compounds: aldicarb, oxamyl, thiodicarb, carbofuran, carbosulfan, and dimethoate;

organic phosphorous compounds: fenamiphos, imicyafos, fensulfothion, terbufos, fosthiazate, phosphocarb, dichlofenthion, isamidofos, isazophos, ethoprophos, cadusafos, chlorpyrifos, heterofos, mecarphon, phorate, thionazin, triazophos, diamidafos, fosthietan, and phosphamidon;

biological nematicidal compounds: Harpin Protein, Pasteuria nishizawae, Pasteuria penetrans, Myrothecium verrucaria, Burkholderia cepacia, Bacillus chitonosporus, Paecilomyces lilacinus, Bacillus amyloliquefaciens, Bacillus firmus, Bacillus subtillis, Bacillus pumulis, Trichoderma harzianum, Hirsutella rhossiliensis, Hirsutella minnesotensis, Verticillium chlamydosporum, and Arthrobotrys dactyloides;

other insecticidal compounds and nematicidal compounds: fipronil, ethiprole, sulfoxaflor, flupyradifurone, beta-cyfluthrin, tefluthrin, chlorpyrifos, abamectin, spirotetramat, and fluensulfone;

azole compounds: azaconazole, bitertanol, bromuconazole, cyproconazole, difenoconazole, diniconazole, epoxyconazole, fenbuconazole, fluquinconazole, flusilazole, flutriafol, hexaconazole, imibenconazole, ipconazole, metconazole, myclobutanil, penconazole, propiconazole, prothioconazole, simeconazole, tebuconazole, tetraconazole, triadimenol, triticonazole, fenarimol, nuarimol, pyrifenox, imazalil, oxpoconazole-fumarate, pefurazoate, prochloraz, and triflumizole;

strobilurin compounds: kresoxim-methyl, azoxystrobin, trifloxystrobin, fluoxastrobin, picoxystrobin, pyraclostrobin, dimoxystrobin, pyribencarb, metominostrobin, orysastrobin, and N-methyl-2-[2-(2,5-dimethylphenoxyl)methyl]phenyl-2-methoxy-acetamide (racemic or enantiomer, containing a mixture of R-enantiomer and S-enantiomer (optional ratio));

metalaxyl compounds: metalaxyl and metalaxyl-M;

SDHI compounds: sedaxane, penflufen, carboxin, boscalid, furametpyr, flutolanil, fluxapyroxad, isopyrazam, fluopyram, and thifluzamide;

other fungicidal compounds: tolclophos-methyl, thiram, captan, carbendazim, thiophanate-methyl, mancozeb, thiabendazole, isotianil, triazoxide, (RS)-2-methoxy-N-methyl-2-[α-(2,5-xylyloxy)-o-tolyl]acetamide, fludioxonil, ethaboxam, 3-chloro-5-phenyl-6-methyl-4-(2,6-difluorophenyl)pyridazine, 3-cyano-5-phenyl-6-methyl-4-(2,6-difluorophenyl)pyridazine, and N-(1,1,3-trimethylindan-4-yl)-1-methyl-3-difluoromethylpyrazole-4-carboxylic acid amide (racemic or enantiomer, containing a mixture of R-enantiomer and S-enantiomer (optional ratio)); and

plant growth regulators: ethephon, chlormequat-chloride, mepiquat-chloride, and 4-oxo-4-(2-phenylethyl)aminobutyric acid.

[5] The control method according to any one of [1] to [4], the method comprising the step of treating the crop field with the PPO-inhibiting compound before the crop seeds are sowed or vegetative organs such as tubers, bulbs, or stem fragments are planted.

[6] The control method according to any one of [1] to [4], the method comprising the step of treating the crop field with the PPO-inhibiting compound at the same time of sowing of the crop seeds or plating of vegetative organs such as tubers, bulbs, or stem fragments.

[7] The control method according to anyone of [1] to [4], the method comprising the step of treating the crop field with the PPO-inhibiting compound after the crop seeds are sowed or vegetative organs such as tubers, bulbs, or stem fragments are planted.

[8] The control method according to anyone of [1] to [7], wherein the crop is wheat, barley, rye, triticale, oat, rice, sorghum, peanut, pulses except for soybean and peanut, sugar beet, rapeseed, sunflower, potato, sugar cane, or vegetables.

Pests in crop fields can be controlled by the method of controlling pests according to the present invention.

### DETAILED DESCRIPTION OF THE PREFERRED EMBODIMENTS

A method of controlling pests according to the present invention includes the steps of:

(1) treating crop seeds or vegetative organs such as tubers, bulbs, or stem fragments with one or more compounds selected from a compound group A including specific insecticidal compounds, nematicidal compounds, and fungicidal compounds; and

(2) treating a crop field with one or more PPO-inhibiting compounds selected from flumioxazin, sulfentrazone, saflufenacil, oxyfluorfen and fomesafen-sodium, before sowing or planting, at the same time of sowing or planting, or after sowing or planting the crop seeds or vegetative organs such as tubers, bulbs, or stem fragments which are treated with the compounds of the compound group A.

Examples of the crops to which the method of the present invention is applied include food crops such as wheat, barley, rye, triticale, rice, peanut, common bean, lima bean, azuki bean, cowpeas, mung bean, black lentil, scarlet runner bean, vigna umbellate, moth bean, tepary bean, broad bean, pea, garbanzo bean, lentil, lupine, pigeon pea, and potato; forage crops such as sorghum, oat, and alfalfa; industrial crops such as sugar beet, sunflower, rapeseed, and sugar cane; and garden crops including vegetables. Examples of the vegetables to which the present invention is applied include Solanaceae vegetables (for example, eggplant, tomato, green pepper, bell pepper, and hot pepper); Cucurbitaceae vegetables (for example, cucumber, pumpkin, zucchini, watermelon, and melon); Cruciferous vegetables (for example, Japanese radish, turnip, horseradish, kohlrabi, Chinese cabbage, cabbage, brown mustard, broccoli, and cauliflower); Compositae vegetables (for example, burdock, garland chrysanthemum, artichoke, and lettuce); Liliaceae vegetables (for example, Welsh onion, onion, garlic, asparagus); Umbelliferae vegetables (carrot, parsley, celery, and parsnip); Chenopodiaceae vegetables (for example, spinach and Swiss chard); Labiatae vegetables (for example, Japanese mint, mint, basil, and lavender); strawberry; sweet potato; yam; and aroid.

The method of the present invention is applied particularly to wheat, barley, rye, triticale, oat, rice, sorghum, peanut, pulses except for soybean and peanut, sugar beet, rapeseed, sunflower, potato, sugar cane, and vegetables.

When the method of the present invention is applied to sugar cane, stem fragments cut so as to have one stalk may be used as the stem fragment of sugar cane, or stem fragments having a size of 2 cm to 15 cm may be used in the cultivation of sugar cane. Sugarcane cultivation methods using such stem fragments are disclosed in WO 09/000398, WO 09/000399, WO 09/000400, WO 09/000401 and WO 09/000402, and performed under the brand name of Plene (trademark).

The above crops include plants to which resistance to PPO-inhibiting compounds such as flumioxazin; 4-hydroxyphenylpyrubic acid dioxygenase inhibitors such as isoxaflutole; acetolactate synthase (hereinafter abbreviated as ALS) inhibitors such as imazethapyr and thifensulfuron-methyl; 5-enolpyruvylshikimate-3-phosphoric acid synthase (hereinafter abbreviated as EPSP) inhibitors such as glyphosate; glutamine synthetase inhibitors such as glufosinate; auxin type herbicides such as 2,4-D and dicamba; and herbicides such as bromoxinyl are imparted by classical breeding methods or genetic modification technologies.

As examples of crops to which resistance has been imparted by classical breeding methods, rice, wheat, sunflower, and canola resistant to imidazolinone type herbicides such as imazethapyr have been commercially available under the trade name of Clearfield (trademark). Also, examples of crops to which resistance is imparted by genetic modification technologies include rapeseed, sugar beet, and rice resistant to glyphosate and glufosinate, and these crops have been already commercially available under the trade name of RoundupReady (trademark) and LibertyLink (trademark).

The above crops include, for example, crops which can synthesize selective toxins and the like known as the genus Bacillus by using genetic modification technologies.

Examples of the toxins developed in such genetically modified plants include insecticidal proteins derived from Bacillus cereus and Bacillus popilliae; δ-endotoxins such as Cry1Ab, Cry1Ac, Cry1F, Cry1Fa2, Cry2Ab, Cry3A, Cry3Bb1, Cry9C, Cry34ab and Cry35ab derived from Bacillus thuringiensis; insecticidal proteins such as VIP1, VIP2, VIP3, and VIP3A; insecticidal proteins derived from nematodes; toxins produced by animals such as scorpion toxins, spider toxins, bee toxins, and neurotoxins specific to insects; filamentous fungus toxins; plant lectins; agglutinin; trypsin inhibitors, serine protease inhibitors, and protease inhibitors such as patatin, cystatin, and papain inhibitors; ribosome inactivating proteins (RIP) such as lysine, corn-RIP, abrin, lufin, saporin, and bryodin; steroid metabolic enzymes such as 3-hydroxysteroid oxidase, ecdysteroid-UDP-glucosyltransferase, and cholesterol oxidase; ecdysone inhibitors; HMG-CoA reductase; ion channel inhibitors such as sodium channel and calcium channel inhibitors; juvenile hormone esterase; diuretic hormone receptors; stilbene synthase; bibenzyl synthase; chitinase; and glucanase.

The toxins expressed in these transgenic plants include hybrid toxins, partially deficient toxins and modified toxins, which derive from δ-endotoxin proteins such as Cry1Ab, Cry1Ac, Cry1F, Cry1Fa2, Cry2Ab, Cry3A, Cry3Bb1, Cry9C, Cry34Ab and Cry35Ab, and insecticidal proteins such as VIP1, VIP2, VIP3 and VIP3A. The hybrid toxins are created by new combinations of domains having different proteins by using genetic modification technologies. As the partially defective toxins, Cry1Ab in which part of the amino acid sequences is missing is known. In the modified toxin, one or more of amino acids of a natural type toxin is replaced. Examples of these toxins and genetically modified plants capable of synthesizing these toxins are described in, for example, EP-A-0374753, WO 93/07278, WO 95/34656, EP-A-0427529, EP-A-451878, and WO 03/052073. Resistance to noxious insects belonging to order Coleoptera, order Diptera, and order Lepidoptera is imparted to plants by toxins contained in these genetically modified plants.

Also, genetically modified plants which contain one or more insecticidal genes resistant to harmful insects and develop one or more toxins have been already known and some of these plants have been put on the market.

The plants to be used in the present invention include those provided with resistance to nematodes by using a classical breeding method or genetic modification technologies. Examples of the genetic modification technologies used to provide the resistance to nematodes include RNAi.

The above crops include those to which the ability to produce antipathogenic substances having a selective effect is imparted using genetic modification technologies. For example, PR proteins are known as an example of the antipathogenic substance (PRPs, EP-A-0392225). Such antipathogenic substances and genetically modified plants producing these antipathogenic substances are described in, for example, EP-A-0392225, WO 95/33818, and EP-A-0353191. Examples of the antipathogenic substances developed in such genetically modified plants include ion channel inhibitors such as a sodium channel inhibitor and calcium channel inhibitor (KP1, KP4, and KP6 toxins produced by virus are known); stilbene synthase; bibenzyl synthase; chitinase; glucanase; PR protein; antipathogenic substances produced by microorganisms such as peptide antibiotics, antibiotics having a heteroring, and a protein factor (referred to as a plant disease resistant gene and described in WO 03/000906) relating to plant disease resistance.

The above crops include plants to which useful traits such as oil component reformation, amino acid-content reinforcing trait, and allergen reduction trait are given by genetic modification technologies.

Moreover, the above crops include stuck varieties obtained by combining two or more useful traits such as the above classical herbicide trait or herbicide resistant gene, gene resistant to insecticidal noxious insects, antipathogenic substance-producing gene, oil component reformation, amino acid-content reinforcing trait, and allergen reduction trait.

In the present invention, examples of the compounds of the compound group A including specific insecticidal compounds, nematicidal compounds, fungicidal compounds, or plant growth regulators used to treat crop seeds or vegetative organs such as tubers, bulbs, or stem fragments include neonicotinoid compounds, diamide compounds, carbamate compounds, organic phosphorous compounds, biological nematicidal compounds, other insecticidal compounds and nematicidal compounds, azole compounds, strobilurin compounds, metalaxyl compounds, SDHI compounds, and other fungicidal compounds and plant growth regulators.

Examples of the neonicotinoid compounds in the present invention include the followings:

clothianidin, imidacloprid, nitenpyram, acetamiprid, thiamethoxam, thiacloprid, and dinotefuran.

Examples of the diamide compounds in the present invention include the followings:

flubendiamide, chlorantraniliprole, cyantraniliprole, and compounds represented by the formula (II):

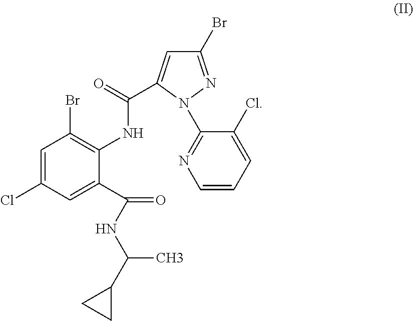 [SMILES: CC(NC(=O)c1cc(Cl)cc(Br)c1NC(=O)c1cc(Br)nn1-c1ncccc1Cl)C1CC1]

Examples of the carbamate compounds in the present invention include the followings:

aldicarb, oxamyl, thiodicarb, carbofuran, carbosulfan, and dimethoate.

Examples of the organic phosphorous compounds in the present invention include the followings:

fenamiphos, imicyafos, fensulfothion, terbufos, fosthiazate, phosphocarb, dichlofenthion, isamidofos, isazophos, ethoprophos, cadusafos, chlorpyrifos, heterofos, mecarphon, phorate, thionazin, triazophos, diamidafos, fosthietan, and phosphamidon.

Examples of the biological nematicidal compounds in the present invention include the followings:

Harpin Protein, Pasteuria nishizawae, Pasteuria penetrans, Myrothecium verrucaria, Burkholderia cepacia, Bacillus chitonosporus, Paecilomyces lilacinus, Bacillus amyloliquefaciens, Bacillus firmus, Bacillus subtillis, Bacillus pumulis, Trichoderma harzianum, Hirsutella rhossiliensis, Hirsutella minnesotensis, Verticillium chlamydosporum, and Arthrobotrys dactyloides.

Examples of the other insecticidal compounds and nematicidal compounds in the present invention include the followings:

fipronil, ethiprole, flupyradifurone, sulfoxaflor, beta-cyfluthrin, tefluthrin, chlorpyrifos, abamectin, spirotetramat, and fluensulfone.

Examples of the azole compounds in the present invention include the followings:

azaconazole, bitertanol, bromuconazole, cyproconazole, difenoconazole, diniconazole, epoxyconazole, fenbuconazole, fluquinconazole, flusilazole, flutriafol, hexaconazole, imibenconazole, ipconazole, metconazole, myclobutanil, penconazole, propiconazole, prothioconazole, simeconazole, tebuconazole, tetraconazole, triadimenol, triticonazole, fenarimol, nuarimol, pyrifenox, imazalil, oxpoconazole fumarate, pefurazoate, prochloraz, and triflumizole.

Examples of the strobilurin compounds in the present invention include the followings:

kresoxim-methyl, azoxystrobin, trifloxystrobin, fluoxastrobin, picoxystrobin, pyraclostrobin, dimoxystrobin, pyribencarb, metominostrobin, orysastrobin, and N-methyl-2-[2-(2,5-dimethylphenoxyl)methyl]phenyl-2-methoxyacetamide (racemic or enantiomer, containing a mixture of R-enantiomer and S-enantiomer (optional ratio), hereinafter referred to as a compound 1).

Examples of the metalaxyl compounds include the followings:

metalaxyl and metalaxyl-M (also known as mefenoxam).

Examples of the SDHI compounds in the present invention include the followings:

sedaxane, penflufen, carboxin, boscalid, furametpyr, flutolanil, fluxapyroxad, isopyrazam, fluopyram, and thifluzamide.

Examples of the other fungicidal compounds in the present invention include the followings:

tolclophos-methyl, thiram, Captan, carbendazim, thiophanate-methyl, mancozeb, thiabendazole, isotianil, triazoxide, (RS)-2-methoxy-N-methyl-2-[α-(2,5-xylyloxy)-o-tolyl]acetamide, fludioxonil, ethaboxam, 3-chloro-5-phenyl-6-methyl-4-(2,6-difluorophenyl)pyridazine (hereinafter referred to as a compound 2), 3-cyano-5-phenyl-6-methyl-4-(2,6-difluorophenyl)pyridazine (hereinafter referred to as a compound 3), and N-(1,1,3-trimethylindan-4-yl)-1-methyl-3-difluoromethylpyrazole-4-carboxylic acid amide (racemic or enantiomer, containing a mixture of R-enantiomer and S-enantiomer (optional ratio), hereinafter referred to as a compound 4).

Examples of the plant growth regulators in the present invention include the followings:

ethephon, chlormequat-chloride, mepiquat-chloride, and 4-oxo-4-(2-phenylethyl)aminobutyric acid (hereinafter referred to as a compound 5).

In the present invention, the compounds of the group A used to treat crop seeds or vegetative organs such as tubers, bulbs, or stem fragments are publicly known compounds, and may be synthesized based on well known patent documents. Also, commercially available preparations or standard products may be purchased and used as the compounds of the group A.

In the step of treating crop seeds or vegetative organs such as tubers, bulbs, or stem fragments with the compounds of the group A in the present invention, the compounds of the group A are usually mixed with a carrier such as a solid carrier or liquid carrier and further added with auxiliaries for preparations such as surfactants according to the need to be formulated into preparations. The dosage is preferably an aqueous suspension preparation.

As the compounds of the compound A used to treat crop seeds or vegetative organs such as tubers, bulbs, or stem fragments in the present invention, a preparation constituted of a single component may be used, two or more preparations each constituted of a single component may be used in combination, or a preparation constituted of two or more components may be used.

The compounds of the group A used for the above treatment are applied in an amount of usually 0.2 to 5000 g, and preferably 0.5 to 1000 g based on 100 kg of the crop seeds or vegetative organs such as tubers, bulbs, or stem fragments. Examples of a method for applying effective components to the crop seeds or vegetative organs such as tubers, bulbs, or stem fragments include a method in which the crop seeds or vegetative organs such as tubers, bulbs, or stem fragments are powder-coated with a preparation containing effective components; a method in which the crop seeds or vegetative organs such as tubers, bulbs, or stem fragments are dipped in a preparation containing effective components; a method in which a preparation containing effective components is sprayed on the crop seeds or vegetative organs such as tubers, bulbs, or stem fragments; and a method in which the crop seeds or vegetative organs such as tubers, bulbs, or stem fragments are coated with a carrier containing effective components.

The present invention includes the step of treating a crop field with at least one PPO-inhibiting compound before sowing or planting, at the same time of sowing or planting, or after sowing or planting the crop seeds or vegetative organs such as tubers, bulbs, or stem fragments which are treated with the compounds of the compound group A.

Examples of the PPO-inhibiting compound in the present invention include flumioxazin, sulfentrazone, saflufenacil, oxyfluorfen and fomesafen-sodium.

These PPO-inhibiting compounds are all publicly known and the commercially available preparations or the standard products may be purchased and used.

In the step of treating a field with the PPO-inhibiting compound, the PPO-inhibiting compound is usually mixed with a carrier such as a solid carrier or liquid carrier and further added with auxiliaries for preparations such as surfactants according to the need to be formulated into preparations.

Examples of a method for applying the PPO-inhibiting compound to a field include a method in which the PPO-inhibiting compound is sprayed on field soil and a method in which the PPO-inhibiting compound is sprayed on weeds after the weeds germinate.

The amount of the PPO-inhibiting compound used in the step of applying the PPO-inhibiting compound to a field is usually 5 to 5000 g, preferably 10 to 1000 g, and more preferably 20 to 500 g per 10000 m². In this case, adjuvants may be added to the PPO-inhibiting compound to apply the PPO-inhibiting compound to the field.

In the present invention, the crop seeds or vegetative organs such as tubers, bulbs, or stem fragments treated with the compounds of the group A are sowed or planted in a field by a usual method. In the method of controlling pests according to the present invention, a crop field may be treated with the PPO-inhibiting compound before sowing or planting, at the same time of sowing or planting, or after sowing or planting the crop seeds or vegetative organs such as tubers, bulbs, or stem fragments.

When a crop field is treated with the PPO-inhibiting compound before sowing or planting the crop seeds or vegetative organs such as tubers, bulbs, or stem fragments, the PPO-inhibiting compound is applied before 50 days to immediately before sowing or planting, preferably before 30 days to immediately before sowing or planting, more preferably before 20 days to immediately before sowing or planting, and even more preferably before 10 days to immediately before sowing or planting.

When a crop field is treated with the PPO-inhibiting compound after sowing or planting the crop seeds or vegetative organs such as tubers, bulbs, or stem fragments, the PPO-inhibiting compound is applied immediately after to 50 days after sowing or planting.

The method of controlling pests according to the present invention ensures that harmful arthropods, noxious nematodes and/or plant pathogens, and pests such as weeds in crop fields can be controlled.

As harmful arthropods, the following examples are given.

Noxious insects belonging to order Hemiptera: Delphacidae such as Laodelphax striatellus, Nilaparvata lugens, and Sogatella furcifera, Deltocephalidae such as Nephotettix cincticeps and Nephotettix virescens, Aphididae such as Aphis gossypii, Myzus persicae, Brevicoryne brassicae, Macrosiphum euphorbiae, Aulacorthum solani, Rhopalosiphum padi, and Toxoptera citricidus, Pentatomidae such as Nezara antennata, Riptortus clavetus, Leptocorisa chinensis, Eysarcoris parvus, Halyomorpha mista, and Lygus lineolaris, Aleyrodidae such as Trialeurodes vaporariorum, Bemisia tabaci, and Bemisia argentifolii, Coccidae such as Aonidiella aurantii, Comstockaspis perniciosa, Unaspis citri, Ceroplastes rubens, and Icerya purchase, Tingidae, and Psyllidae;

noxious insects belonging to order Lepidoptera: Pyralidae such as Chilo suppressalis, Tryporyza incertulas, Cnaphalocrocis medinalis, Notarcha derogate, Plodia interpunctella, Ostrinia furnacalis, Ostrinia nubilaris, Hellula undalis, and Pediasia teterrellus, Noctuidae such as Spodoptera litura, Spodoptera exigua, Pseudaletia separate, Mamestra brassicae, Agrotis ipsilon, Plusia nigrisigna, Trichoplusia spp., Heliothis spp., and Helicoverpa spp., Pieridae such as Pieris rapae, Tortricidae such as Adoxophyes spp., Grapholita molesta, Leguminivora glycinivorella, Matsumuraeses azukivora, Adoxophyes orana fasciata, Adoxophyes sp., Homona magnanima, Archips fuscocupreanus, and Cydia pomonella, Gracillariidae such as Caloptilia theivora and Phyllonorycter ringoneella, Carposinidae such as Carposina niponensis, Lyonetiidae such as Lyonetia spp., Lymantriidae such as Lymantriidae spp. and Euproctis spp., Yponameutidae such as Plutella xylostella, Gelechiidae such as Pectinophora gossypiella and Phthorimaea operculella, Arctiidae such as Hyphantria cunea, and Tineidae such as Tinea translucens and Tineola bisselliella;

noxious insects belonging to order Thripidae: Thysanoptera such as Frankliniella occidentalis, Thripsparmi, Scirtothrips dorsalis, Thrips tabaci, Frankliniella intonsa, and Frankliniella fusca;

noxious insects belonging to order Diptera: Agromyzidae such as Musca domestica, Culex popiens pallens, Tabanus trigonus, Hylemya antique, Hylemya platura, Anopheles sinensis, Agromyza oryzae, Hydrellia griseola, Chlorops oryzae, and Liriomyza trifolii, Dacus cucurbitae, and Ceratitis capitata;

noxious insects belonging to order Coleoptera: Epilachna vigintioctopunctata, Aulacophora femoralis, Phyllotreta striolata, Oulema oryzae, Echinocnemus squameus, Lissorhoptrus oryzophilus, Anthonomus grandis, Callosobruchus chinensis, Sphenophorus venatus, Popillia japonica, Anomala cuprea, Diabrotica spp., Leptinotarsa decemlineata, Agriotes spp., Lasioderma serricorne, Anthrenus verbasci, Tribolium castaneum, Lyctus brunneus, Anoplophora malasiaca, and Tomicus piniperda;

noxious insects belonging to order Orthoptera: Locusta migratoria, Gryllotalpa africana, Oxya yezoensis, and Oxya japonica;

noxious insects belonging to order Hymenoptera: Athalia rosae, Acromyrmex spp., and Solenopsis spp.;

noxious insects belonging to order Blattidae: Blattella germanica, Periplaneta fuliginosa, Periplaneta americana, Periplaneta brunnea, and Blatta orientalis; and

noxious insects belonging to order Acarina: Tetranychidae such as Tetranychus urticae, Panonychus citri, and Oligonychus spp., Eriophyidae such as Aculops pelekassi, Tarsonemidae such as Polyphagotarsonemus latus, Tenuipalpidae, Tuckerellidae, Acaridae such as Tyrophagus putrescentiae, Dermanyssidae such as Dermatophagoides farina and Dermatophagoides ptrenyssnus, and Cheyletidae such as Cheyletus eruditus, Cheyletus malaccensis, and Cheyletus moorei.

As the plant pathogens, the following examples can be given.

Cercospora gossypina, Cercospora kikuchii, Cercospora zeae-maydis, Cercospora sojina, Phakopsora gossypii, Rhizoctonia solani, Colletotrichum gossypii, Peronospora gossypina, Aspergillus spp., Penicillium spp., Fusarium spp., Tricoderma spp., Thielaviopsis spp., Rhizopus spp., Mucor spp., Corticium spp., Phoma spp., Diplodia spp., Verticillium spp., Puccinia spp., Mycosphaerella spp., Phytophthora spp. (for example, Phytophthora sojae, Phytophthora nicotianae var. nicotianae, Phytophthora infestans, and Phytophthora erythroseptica), Pythium spp. (for example, Pythium debaryanum, Pythium sylvaticum, Pythium graminicola, Pythium irregular, and Pythium ultimum), Microsphaera diffusa, Diaporthe phaseolorum var. sojae, Septoria glycines, Phakopsora pachyrhizi, Sclerotinia sclerotiorum, Elsinoe glycines, Ustilago maydis, Cochliobolus heterostrophus, Gloeocercospora sorghi, and Alternaria spp.

As the weeds, the following examples are given.

Weeds of the family Urticaceae: Urtica urens;

weeds of the family Polygonaceae: Polygonum convolvulus, Polygonum lapathifolium, Polygonum pensylvanicum, Polygonum persicaria, Polygonum longisetum, Polygonum aviculare, Polygonum arenastrum, Polygonum cuspidatum, Rumex japonicas, Rumex crispus, Rumex obtusifolius, and Rumex acetosa;

weeds of the family Portulacaceae: Portulaca oleracea;

weeds of the family Caryophyllaceae: Stellaria media, Cerastium holosteoides, Cerastium glomeratum, Spergula arvensis, and Silene gallica;

weeds of the family Molluginaceae: Mollugo verticillata;

weeds of the family Chenopodiaceae: Chenopodium album, Chenopodium ambrosioides, Kochia scoparia, Salsola kali, and Atriplex spp.;

weeds of the family Amaranthaceae: Amaranthus retroflexus, Amaranthus viridis, Amaranthus lividus, Amaranthus spinosus, Amaranthus hybridus, Amaranthus palmeri, Amaranthus rudis, Amaranthus patulus, Amaranthus tuberculatos, Amaranthus blitoides, Amaranthus deflexus, Amaranthus quitensis, Alternanthera philoxeroides, Alternanthera sessilis, and Alternanthera tenella;

weeds of the family Papaveraceae: Papaver rhoeas and Argemone mexicana;

weeds of the family Brassicaceae: Raphanus raphanistrum, Raphanus sativus, Sinapis arvensis, Capsella bursa-pastoris, Brassica juncea, Brassica campestris, Descurainia pinnata, Rorippa islandica, Rorippa sylvestris, Thlaspi arvense, Myagrum rugosum, Lepidium virginicum, and Coronopus didymus;

weeds of the family Capparaceae: Cleome affinis;

weeds of the family Fabaceae: Aeschynomene indica, Aeschynomene rudis, Sesbania exaltata, Cassia obtusifolia, Cassia occidentalis, Desmodium tortuosum, Desmodium adscendens, Trifolium repens, Pueraria lobata, Vicia angustifolia, Indigofera hirsute, Indigofera truxillensis, and Vigna sinensis;

weeds of the family Oxalidaceae: Oxalis corniculata, Oxalis strica, and Oxalis oxyptera;

weeds of the family Geraniaceae: Geranium carolinense and Erodium cicutarium;

weeds of the family Euphorbiaceae: Euphorbia helioscopia, Euphorbia maculate, Euphorbia humistrata, Euphorbia esula, Euphorbia heterophylla, Euphorbia brasiliensis, Acalypha australis, Croton glandulosus, Croton lobatus, Phyllanthus corcovadensis, and Ricinus communis;

weeds of the family Malvaceae: Abutilon theophrasti, Sida rhombiforia, Sida cordifolia, Sida spinosa, Sida glaziovii, Sida santaremnensis, Hibiscus trionum, Anoda cristata, and Malvastrum coromandelianum;

weeds of the family Sterculiaceae: Waltheria indica;

weeds of the family Violaceae: Viola arvensis, and Viola tricolor;

weeds of the family Cucurbitaceae: Sicyos angulatus, Echinocystis lobata, and Momordica charantia;

weeds of the family Lythraceae: Lythrum salicaria;

weeds of the family Apiaceae: Hydrocotyle sibthorpioides;

weeds of the family Sapindaceae: Cardiospermum halicacabum;

weeds of the family Primulaceae: Anagallis arvensis;

weeds of the family Asclepiadaceae: Asclepias syriaca and Ampelamus albidus;

weeds of the family Rubiaceae: Galium aparine, Galium spurium var. echinospermon, Spermacoce latifolia, Richardia brasiliensis, and Borreria alata;

weeds of the family Convolvulaceae: Ipomoea nil, Ipomoea hederacea, Ipomoea purpurea, Ipomoea hederacea var. integriuscula, Ipomoea lacunose, Ipomoea triloba, Ipomoea acuminate, Ipomoea hederifolia, Ipomoea coccinea, Ipomoea quamoclit, Ipomoea grandifolia, Ipomoea aristolochiafolia, Ipomoea cairica, Convolvulus arvensis, Calystegia hederacea, Calystegia japonica, Merremia hedeacea, Merremia aegyptia, Merremia cissoids, and Jacquemontia tamnifolia;

weeds of the family Boraginaceae: Myosotis arvensis;

weeds of the family Lamiaceae: Lamium purpureum, Lamium amplexicaule, Leonotis nepetaefolia, Hyptis suaveolens, Hyptis lophanta, Leonurus sibiricus, and Stachys arvensis;

weeds of the family Solanaceae: Datura stramonium, Solanum nigrum, Solanum americanum, Solanum ptycanthum, Solanum sarrachoides, Solanum rostratum, Solanum aculeatissimum, Solanum sisymbriifolium, Solanum carolinense, Physalis angulata, Physalis subglabrata, and Nicandra physaloides;

weeds of the family Scrophulariaceae: Veronica hederaefolia, Veronica persica, and Veronica arvensis;

weeds of the family Plantaginaceae: Plantago asiatica;

weeds of the family Asteraceae: Xanthium pensylvanicum, Xanthium occidentale, Helianthus annuus, Matricaria chamomilla, Matricaria perforate, Chrysanthemum segetum, Matricaria matricarioides, Artemisia princeps, Artemisia vulgaris, Artemisia verlotorum, Solidago altissima, Taraxacum officinale, Galinsoga ciliate, Galinsoga parviflora, Senecio vulgaris, Senecio brasiliensis, Senecio grisebachii, Conyza bonariensis, Conyza Canadensis, Ambrosia artemisiaefolia, Ambrosia trifida, Bidens pilosa, Bidens frondosa, Bidens subalternans, Cirsium arvense, Cirsium vulgare, Silybum marianum, Carduus nutans, Lactuca serriola, Sonchus oleraceus, Sonchus asper, Wedelia glauca, Melampodium perfoliatum, Emilia sonchifolia, Tagetes minuta, Blainvillea latifolia, Tridax procumbens, Porophyllum ruderale, Acanthospermum australe, Acanthospermum hispidum, Cardiospermum halicacabum, Ageratum conyzoides, Eupatorium perfoliatum, Eclipta alba, Erechtites hieracifolia, Gamochaeta spicata, Gnaphalium spicatum, Jaegeria hirta, Parthenium hysterophorus, Siegesbeckia orientalis, and Soliva sessilis;

weeds of the family Liliaceae: Allium canadense and Allium vineale;

weeds of the family Commelinaceae: Commelina communis, Commelina bengharensis, and Commelina erecta;

weeds of the family Poaceae: Echinochloa crus-galli, Setaria viridis, Setaria faberi, Setaria glauca, Setaria geniculata, Digitaria ciliaris, Digitaria sanguinalis, Digitaria horizontalis, Digitaria insularis, Eleusine indica, Poa annua, Alospecurus aequalis, Alopecurus myosuroides, Avena fatua, Sorghum halepense, Sorghum vulgare, Agropyron repens, Lolium multiflorum, Lolium perenne, Lolium rigidum, Bromus secalinus, Bromus tectorum, Hordeum jubatum, Aegilops cylindrica, Phalaris arundinacea, Phalaris minor, Apera spica-venti, Panicum dichotomiflorum, Panicum texanum, Panicum maximum, Brachiaria platyphylla, Brachiaria ruziziensis, Brachiaria plantaginea, Brachiaria decumbens, Brachiaria brizantha, Brachiaria humidicola, Cenchrus echinatus, Cenchrus pauciflorus, Eriochloa villosa, Pennisetum setosum, Chloris gayana, Eragrostis pilosa, Rhynchelitrum repens, Dactyloctenium aegyptium, Ischaemum rugosum, Oryza sativa, Paspalum notatum, Paspalum maritimum, Pennisetum clandestinum, Pennisetum setosum, and Rottboellia cochinchinensis;

weeds of the family Cyperaceae: Cyperus microiria, Cyperus iria, Cyperus odoratus, Cyperus rotundus, Cyperus esculentus, and Kyllinga gracillima; and

weeds of the family Equisetaceae: Equisetum arvense and Equisetum palustre.

In the method of controlling pests of the present invention, one or more other agrochemicals may be used in combination with the compounds of the group A or the PPO-inhibiting compound either simultaneously or separately. Examples of the other agrochemicals include insecticides, acaricides, nematicides, germicides, herbicides, plant growth regulators, and safeners.

As the above herbicides, plant growth regulators, and safeners, the following examples are given.

Herbicides: dicamba and a salt thereof (diglycolamine salt, dimethylammonium salt, isopropylammonium salt, potassium salt, sodium salt and choline salt), 2,4-D and a salt or ester thereof (butotyl ester, dimethylammonium salt, diolamine salt, ethylhexyl ester, isooctyl ester, isopropylammonium salt, sodium salt and triisopropanolamine salt), 2,4-DB and a salt or ester thereof (dimethylammonium salt, isooctyl ester and choline salt), MCPA and a salt or ester thereof (dimethylammonium salt, 2-ethylhexylester, isooctyl ester, sodium salt and choline salt), MCPB, mecoprop and a salt or ester thereof (dimethylammonium salt, diolamine salt, ethadyl ester, 2-ethylhexyl ester, isooctyl ester, methyl ester, potassium salt, sodium salt, tololamine salt and choline salt), mecoprop-P and a salt or ester thereof (dimethylammonium salt, 2-ethylhexyl ester, isobutyl salt, potassium salt and choline salt), dichlorprop and a salt or ester thereof (butotyl ester, dimethylammonium salt, 2-ethylhexyl ester, isooctyl ester, methyl ester, potassium salt, sodium salt and choline salt), dichlorprop-P, dichlorprop-P dimethylammonium, bromoxynil, bromoxynil-octanoate, dichlobenil, metiozolin, ioxynil, ioxynil-octanoate, di-allate, butylate, tri-allate, phenmedipham, chlorpropham, asulam, phenisopham, benthiocarb, molinate, esprocarb, pyributicarb, prosulfocarb, orbencarb, EPIC, dimepiperate, swep, propachlor, metazachlor, alachlor, acetochlor, metolachlor, S-metolachlor, butachlor, pretilachlor, thenylchlor, aminocyclopyrachlor, aminocyclopyrachlor-methyl, aminocyclopyrachlor-potassium, trifluralin, pendimethalin, ethalfluralin, benfluralin, prodiamine, simazine, atrazine, propazine, cyanazine, ametryn, simetryn, dimethametryn, prometryn, indaziflam, triaziflam, metribuzin, hexazinone, isoxaben, diflufenican, diuron, linuron, fluometuron, difenoxuron, methyl-daimuron, isoproturon, isouron, tebuthiuron, benzthiazuron, methabenzthiazuron, propanil, mefenacet, clomeprop, naproanilide, bromobutide, daimuron, cumyluron, diflufenzopyr, etobenzanid, bentazon, tridiphane, indanofan, amitrole, fenchlorazole, clomazone, maleic hydrazide, pyridate, chloridazon, norflurazon, bromacil, terbacil, oxaziclomefone, cinmethylin, benfuresate, cafenstrole, pyrithiobac, pyrithiobac-sodium, pyriminobac, pyriminobac-methyl, bispyribac, bispyribac-sodium, pyribenzoxim, pyrimisulfan, pyriftalid, triafamone, fentrazamide, dimethenamid, dimethenamid-P, ACN, bennzobicyclon, dithiopyr, triclopyr and a salt or ester thereof (butotyl ester and triethylammonium salt), fluroxypyr, fluroxypyr-meptyl, thiazopyr, aminopyralid and a salt thereof (potassium salt, triisopanolammonium salt and choline salt), clopyralid and a salt thereof (olamine salt, potassium salt, triethylammonium salt and choline salt), picloram and a salt thereof (potassium salt, triisopanolammonium salt and choline salt), dalapon, chlorthiamid, amidosulfuron, azimsulfuron, bensulfuron, bensulfuron-methyl, chlorimuron, chlorimuron-ethyl, cyclosulfamuron, ethoxysulfuron, flazasulfuron, flucetosulfuron, flupyrsulfuron, flupyrsulfuron-methyl-sodium, foramsulfuron, halosulfuron, halosulfuron-methyl, imazosulfuron, mesosulfuron, mesosulfuron-methyl, metazosulfuron, nicosulfuron, orthosulfamuron, oxasulfuron, primisulfuron, primisulfuron-methyl, propyrisulfuron, pyrazosulfuron, pyrazosulfuron-ethyl, rimsulfuron, sulfometuron, sulfometuron-methyl, sulfosulfuron, trifloxysulfuron-sodium, trifloxysulfuron, chlorsulfuron, cinosulfuron, ethametsulfuron, ethametsulfuron-methyl, iodosulfuron, iodosulfuron-methyl-sodium, iofensulfuron, iofensulfuron-sodium, metsulfuron, metsulfuron-methyl, prosulfuron, thifensulfuron, thifensulfuron-methyl, triasulfuron, tribenuron, tribenuron-methyl, triflusulfuron, triflusulfuron-methyl, tritosulfuron, picolinafen, beflubutamid, bicyclopyrone, mesotrione, sulcotrione, tefuryltrione, tembotrione, isoxachlortole, isoxaflutole, benzofenap, pyrasulfotole, pyrazolynate, pyrazoxyfen, topramezone, flupoxam, amicarbazone, bencarbazone, flucarbazone, flucarbazone-sodium, ipfencarbazone, propoxycarbazone, propoxycarbazone-sodium, thiencarbazone, thiencarbazone-methyl, cloransulam, cloransulam-methyl, diclosulam, florasulam, flumetsulam, metosulam, penoxsulam, pyroxsulam, imazamethabenz, imazamethabenz-methyl, imazamox, imazamox-ammonium, imazapic, imazapic-ammonium, imazapyr, imazapyr-isopropylammonium, imazaquin, imazaquin-ammonium, imazethapyr, imazethapyr-ammonium, clodinafop, clodinafop-propargyl, cyhalofop, cyhalofop-butyl, diclofop, diclofop-methyl, fenoxaprop, fenoxaprop-ethyl, fenoxaprop-P, fenoxaprop-P-ethyl, fluazifop, fluazifop-butyl, fluazifop-P, fluazifop-P-butyl, haloxyfop, haloxyfop-methyl, haloxyfop-P, haloxyfop-P-methyl, metamifop, propaquizafop, quizalofop, quizalofop-ethyl, quizalofop-P, quizalofop-P-ethyl, alloxydim, clethodim, sethoxydim, tepraloxydim, tralkoxydim, pinoxaden, pyroxasulfone, fenoxasulfone, glyphosate, glyphosate-isopropylamine, glyphosate-trimethylsulfonium, glyphosate-ammonium, glyphosate-diammonium, glyphosate-sodium, glyphosate-potassium, glyphosate-guanidine, glufosinate, glufosinate-ammonium, glufosinate-P, glufosinate-P-sodium, bialafos, anilofos, bensulide, butamifos, paraquat, paraquat-dichloride, diquat, and diquat-dibromide.

Plant growth regulators: hymexazol, paclobutrazol, uniconazole, uniconazole-P, inabenfide, prohexadione-calcium, 1-methylcyclopropene, trinexapac-ethyl, and gibberellins.

Safeners: benoxacor, cloquintocet, cloquintocet-mexyl, cyometrinil, cyprosulfamide, dichlormid, dicyclonon, dietholate, fenchlorazole, fenchlorazole-ethyl, fenclorim, flurazole, fluxofenim, furilazole, isoxadifen, isoxadifen-ethyl, mefenpyr, mefenpyr-diethyl, mephenate, naphthalic anhydride, and oxabetrinil.

In the present invention, chlorimuron-ethyl, cloransulam-methyl, pyroxasulfone, imazethapyr-ammonium, metribuzin, 2,4-D, dicamba, mesotrione, tembotrione, isoxaflutole, and ametryn are particularly preferable as the herbicides which may be simultaneously used in combination with the PPO-inhibiting compound.

In the present invention, cyprosulfamide, mefenpyr-diethyl, and isoxadifen-ethyl are particularly preferable as the safener which may be simultaneously used in combination with the PPO-inhibiting compound.

The followings are more preferable as the combinations of the herbicide and/or safener which may be used in combination with the PPO-inhibiting compound:

a combination of flumioxazin and chlorimuron-ethyl;

a combination of flumioxazin and cloransulam-methyl;

a combination of flumioxazin, chlorimuron-ethyl, and pyroxasulfone;

a combination of flumioxazin and pyroxasulfone;

a combination of flumioxazin and imazethapyr-ammonium;

a combination of flumioxazin and metribuzin;

a combination of flumioxazin and 2,4-D;

a combination of flumioxazin and dicamba;

a combination of flumioxazin and mesotrione;

a combination of flumioxazin and tembotrione;

a combination of flumioxazin and isoxaflutole;

a combination of flumioxazin and ametryn;

a combination of flumioxazin, dicamba, and isoxadifen-ethyl;

a combination of flumioxazin, isoxaflutole, and cyprosulfamide; and

a combination of flumioxazin, tembotrione, and isoxadifen.

### EXAMPLES

Hereinbelow, the present invention will be described in detail byway of examples, but the present invention is not limited to these examples.

First, given are the standard of evaluation of pest control effect (harmful arthropod control effect, plant pathogen control effect, herbicidal effect), and that of crop phytotoxicity, which will be shown in examples hereinafter.

[Harmful Arthropod Control Effect]

In the evaluation of the harmful arthropod control effect, each insect at the time of investigation is examined by discriminating whether the insect is alive or dead to calculate a controlling value by the following equation.

Controlling value (%)=100×(1−T/C)

where C represents the number of insects to be observed in an untreated area, and

T represents the number of insects to be observed in a treated area

[Plant Pathogen Control Effect]

In the evaluation of the plant pathogen control effect, the symptom of each test plant in a treated area is compared with that in an untreated area and when there is no or almost no difference in symptom between the treated area and the untreated area at the time of investigation, the case is given “0”, and when no or almost no change in symptom caused by plant pathogens is observed at the time of investigation, the case is given “100”, thereby grading each sample between 0 to 100.

[Herbicidal Effect and Crop Phytotoxicity]

In the evaluation of the herbicidal effect, the germination or growth condition of each test weed in a treated area is compared with that in an untreated area and when there is no or almost no difference in germination or growth condition between the treated area and the untreated area at the time of investigation, the case is given “0”, and when the test plant perfectly withers and dies, or the germination or growth of the plant is perfectly restricted at the time of investigation, the case is given “100”, thereby grading each sample between 0 to 100.

In the evaluation of crop phytotoxicity, the case where almost no crop injury is observed is expressed as “harmless”, the case where mild crop phytotoxicity are observed is expressed as “small”, the case where moderate crop phytotoxicity are observed is expressed as “middle”, and the case where severe crop phytotoxicity are observed is expressed as “large”.

### Example 1

A pot is filled with soil and weeds are sowed, and the surface of the soil is uniformly treated with flumioxazin at a dose of 25, 50, 100, or 200 g/ha. After 15 days, wheat seeds are sowed to which one or more compounds, selected from the compound group A are attached at a dose of 1, 10, or 100 g/100 kg seeds. This pot is placed in a greenhouse. The pest control effect, and crop phytotoxicity are examined 15 days after the wheat seeds are sowed.

### Example 2

A pot is filled with soil and weeds are sowed, and the surface of the soil is uniformly treated with flumioxazin at a dose of 25, 50, 100, or 200 g/ha or with oxyfluorfen at a dose of 100, 200, 400, or 800 g/ha. After 15 days, tomato seeds are sowed to which one or more compounds selected from the compound group A are attached at a dose of 1, 10, or 100 g/100 kg seeds. This pot is placed in a greenhouse. The pest control effect, and crop phytotoxicity are examined 15 days after the tomato seeds are sowed.

### Example 3

A pot is filled with soil and weeds are sowed, and the surface of the soil is uniformly treated with flumioxazin at a dose of 25, 50, 100, or 200 g/ha or with oxyfluorfen at a dose of 100, 200, 400, or 800 g/ha. After 15 days, eggplant seeds are sowed to which one or more compounds selected from the compound group A are attached at a dose of 1, 10, or 100 g/100 kg seeds. This pot is placed in a greenhouse. The pest control effect, and crop phytotoxicity are examined 15 days after the eggplant seeds are sowed.

### Example 4

A pot is filled with soil and weeds are sowed, and the surface of the soil is uniformly treated with flumioxazin at a dose of 25, 50, 100, or 200 g/ha or with oxyfluorfen at a dose of 100, 200, 400, or 800 g/ha. After 15 days, bell pepper seeds are sowed to which one or more compounds selected from the compound group A are attached at a dose of 1, 10, or 100 g/100 kg seeds. This pot is placed in a greenhouse. The pest control effect, and crop phytotoxicity are examined 15 days after the bell pepper seeds are sowed.

### Example 5

A pot is filled with soil and weeds are sowed, and the surface of the soil is uniformly treated with flumioxazin, saflufenacil, or sulfentrazone at a dose of 25, 50, 100, 200, or 400 g/ha. After 15 days, sugar cane stem fragments are planted to which one or more compounds selected from the compound group A are attached at a dose of 1, 10, or 100 g/100 kg stem fragments. This pot is placed in a greenhouse. The pest control effect, and crop phytotoxicity are examined 15 days after the sugar cane stem fragments are planted.

### Example 6

A pot is filled with soil and weeds are sowed, and the surface of the soil is uniformly treated with flumioxazin at a dose of 25, 50, 100, or 200 g/ha or with sulfentrazone at a dose of 50, 100, 200, or 400 g/ha. After 15 days, common bean seeds are sowed to which one or more compounds selected from the compound group A are attached at a dose of 1, 10, or 100 g/100 kg seeds. This pot is placed in a greenhouse. The pest control effect, and crop phytotoxicity are examined 15 days after the common bean seeds are sowed.

### Example 7

A pot is filled with soil and weeds are sowed, and the surface of the soil is uniformly treated with flumioxazin at a dose of 25, 50, 100, or 200 g/ha. After 15 days, rice seeds are sowed to which one or more compounds selected from the compound group A are attached at a dose of 1, 10, or 100 g/100 kg seeds. This pot is placed in a greenhouse. The pest control effect, and crop phytotoxicity are examined 15 days after the rice seeds are sowed.

### Example 8

A pot is filled with soil and weeds are sowed, and the surface of the soil is uniformly treated with a PPO-inhibiting compound at a dose of 25, 50, 100, or 200 g/ha. After 15 days, rapeseeds are sowed to which one or more selected from the compound group A are attached at a dose of 1, 10, or 100 g/100 kg seeds. This pot is placed in a greenhouse. The pest control effect, and crop phytotoxicity are examined 15 days after the rapeseeds are sowed.

### Example 9

A pot is filled with soil and sugar cane stem fragments are planted to which one or more compounds selected from the compound group A are attached at a dose of 1, 10, or 100 g/100 kg stem fragments. Next, the stem fragments are sowed in a cultivated field. After the stem fragments are planted, the stem leaves of weeds are treated directly with flumioxazin, saflufenacil, or sulfentrazone at a dose of 25, 50, 100, 200, or 400 g/ha when the plant height of the sugarcane becomes 60 cm or more. This pot is placed in a greenhouse. The pest control effect, and crop phytotoxicity are examined 28 days after the treatment.

### Example 10

One or more compounds selected from the compound group A are attached to peanut seeds at a dose of 1, 10, or 100 g/100 kg seeds. Then, a pot is filled with soil and the seeds and weed seeds are sowed. On the day of sowing, the surface of the soil is uniformly treated with flumioxazin at a dose of 25, 50, 100, or 200 g/ha. This pot is placed in a greenhouse. The pest control effect, and crop phytotoxicity are examined 15 days after these seeds are sowed.

### Example 11

One or more compounds selected from the compound group A are attached to common bean seeds at a dose of 1, 10, or 100 g/100 kg seeds. Then, a pot is filled with soil and the seeds and weed seeds are sowed. On the day of sowing, the surface of the soil is uniformly treated with flumioxazin at a dose of 25, 50, 100, or 200 g/ha or with sulfentrazone at a dose of 50, 100, 200, or 400 g/ha. This pot is placed in a greenhouse. The pest control effect, and crop phytotoxicity are examined 15 days after these seeds are sowed.

### Example 12

One or more compounds selected from the compound group A are attached to green pea seeds at a dose of 1, 10, or 100 g/100 kg seeds. Then, a pot is filled with soil and the seeds and weed seeds are sowed. On the day of sowing, the surface of the soil is uniformly treated with flumioxazin at a dose of 25, 50, 100, or 200 g/ha or with sulfentrazone at a dose of 50, 100, 200, or 400 g/ha. This pot is placed in a greenhouse. The pest control effect, and crop phytotoxicity are examined 15 days after these seeds are sowed.

### Example 13

One or more compounds selected from the compound group A are attached to sunflower seeds at a dose of 1, 10, or 100 g/100 kg seeds. Then, a pot is filled with soil and the seeds and weed seeds are sowed. On the day of sowing, the surface of the soil is uniformly treated with flumioxazin at a dose of 25, 50, 100, or 200 g/ha or with sulfentrazone at a dose of 50, 100, 200, or 400 g/ha. This pot is placed in a greenhouse. The pest control effect, and crop phytotoxicity are examined 15 days after these seeds are sowed.

### Example 14

One or more compounds selected from the compound group A are attached to sugar cane stem fragments at a dose of 1, 10, or 100 g/100 kg stem fragments. Then, a pot is filled with soil and the stem fragments are planted and weed seeds and sowed. On the day of planting and sowing, the surface of the soil is uniformly treated with flumioxazin, saflufenacil, or sulfentrazone at a dose of 25, 50, 100, 200, or 400 g/ha. This pot is placed in a greenhouse. The pest control effect, and crop phytotoxicity are examined 15 days after these are planted and sowed.

### Example 15

One or more compounds selected from the compound group A are attached to potato tubers at a dose of 1, 10, or 100 g/100 kg tubers. Then, a pot is filled with soil and the tubers are planted and weed seeds and sowed. On the day of planting and sowing, the surface of the soil is uniformly treated with flumioxazin at a dose of 12.5, 25, 50, or 100 g/ha. This pot is placed in a greenhouse. The pest control effect, and crop phytotoxicity are examined 15 days after these are planted and sowed.

### Example 16

One or more compounds selected from the compound group A are attached to onion seeds at a dose of 1, 10, or 100 g/100 kg seeds. Then, a pot is filled with soil and the seeds and weed seeds are sowed. This pot is placed in a greenhouse. When the onion grows 2 to 6 leaves, the surface of the soil and the stem leaves of the weeds are uniformly treated with flumioxazin at a dose of 12.5, 25, 50, or 100 g/ha. The pest control effect, and crop phytotoxicity are examined 15 days after the treatment with flumioxazin.

### Example 17

One or more compounds selected from the compound group A are attached to garlic bulbs at a dose of 1, 10, or 100 g/100 kg bulbs. Then, a pot is filled with soil and the garlic bulbs are planted and weed seeds and sowed. On the day of planting and sowing, the surface of the soil is uniformly treated with flumioxazin at a dose of 50, 100, 200, or 400 g/ha or with oxyfluorfen at a dose of 200, 400, or 800 g/ha. This pot is placed in a greenhouse. The pest control effect, and crop phytotoxicity are examined 15 days after these are planted and sowed.

### Example 18

One or more compounds selected from the compound group A are attached to sunflower seeds at a dose of 1, 10, or 100 g/100 kg seeds. Then, a pot is filled with soil and the seeds and weed seeds are sowed. This pot is placed in a greenhouse. When the sunflower grows 2 to 6 leaves, the surface of the soil and the stem leaves of the weeds are uniformly treated with flumioxazin at a dose of 12.5, 25, 50, or 100 g/ha. The pest control effect, and crop phytotoxicity are examined 15 days after the treatment with flumioxazin.

### Example 19

One or more compounds selected from the compound group A are attached to wheat seeds at a dose of 1, 10, or 100 g/100 kg seeds. Then, a pot is filled with soil and the seeds and weed seeds are sowed. This pot is placed in a greenhouse. When the wheat grows 2 to 6 leaves, the surface of the soil and the stem leaves of the weeds are uniformly treated with flumioxazin at a dose of 12.5, 25, 50, or 100 g/ha. The pest control effect, and crop phytotoxicity are examined 15 days after the treatment with flumioxazin.

According to the method of controlling pests of the present invention, pests in crop fields can be efficiently controlled.

1. A method of controlling weeds in a crop field, the method comprising treating the crop field with one or more PPO-inhibiting compounds selected from flumioxazin, sulfentrazone, saflufenacil, oxyfluorfen and fomesafen-sodium, before sowing or planting, at the same time of sowing or planting, or after sowing or planting crop seeds or vegetative organs such as tubers, bulbs, and stem fragments which are treated with one or more compounds selected from the compound group A:
Compound group A: neonicotinoid compounds, diamide compounds, carbamate compounds, organic phosphorous compounds, biological nematicidal compounds, other insecticidal compounds and nematicidal compounds, azole compounds, strobilurin compounds, metalaxyl compounds, SDHI compounds, and other fungicidal compounds and plant growth regulators.

2. A method of controlling pests in a crop field, the method comprising the steps of:
treating crop seeds or vegetative organs such as tubers, bulbs, or stem fragments with one or more compounds selected from the compound group A:
Compound group A: neonicotinoid compounds, diamide compounds, carbamate compounds, organic phosphorous compounds, biological nematicidal compounds, other insecticidal compounds and nematicidal compounds, azole compounds, strobilurin compounds, metalaxyl compounds, SDHI compounds, and other fungicidal compounds and plant growth regulators; and
treating the crop field with one or more PPO-inhibiting compounds selected from compounds of flumioxazin, sulfentrazone, saflufenacil, oxyfluorfen and fomesafen-sodium, before sowing or planting, at the same time of sowing or planting, or after sowing or planting the crop seeds or vegetative organs such as tubers, bulbs, and stem fragments which are treated with the compounds of the compound group A.

3. The control method according to claim 2, wherein the pests are weeds.

4. The control method according to claim 1, wherein one or more compounds selected from the compound group A is one or more compounds selected from the compound group A-1;
Compound group A-1:
neonicotinoid compounds: clothianidin, thiamethoxam, imidacloprid, dinotefuran, nitenpyram, acetamiprid, and thiacloprid;
diamide compounds: flubendiamide, chlorantraniliprole, cyantraniliprole, and a compound represented by the formula (II): 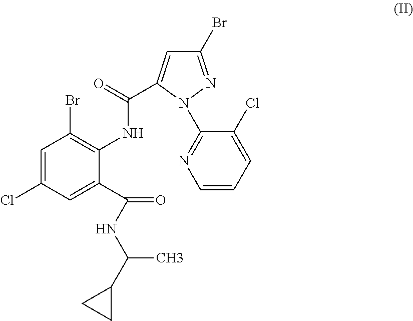 [SMILES: CC(NC(=O)c1cc(Cl)cc(Br)c1NC(=O)c1cc(Br)nn1-c1ncccc1Cl)C1CC1]
carbamate compounds: aldicarb, oxamyl, thiodicarb, carbofuran, carbosulfan, and dimethoate;
organic phosphorous compounds: fenamiphos, imicyafos, fensulfothion, terbufos, fosthiazate, phosphocarb, dichlofenthion, isamidofos, isazophos, ethoprophos, cadusafos, chlorpyrifos, heterofos, mecarphon, phorate, thionazin, triazophos, diamidafos, fosthietan, and phosphamidon;
biological nematicidal compounds: Harpin Protein, Pasteuria nishizawae, Pasteuria penetrans, Myrothecium verrucaria, Burkholderia cepacia, Bacillus chitonosporus, Paecilomyces lilacinus, Bacillus amyloliquefaciens, Bacillus firmus, Bacillus subtillis, Bacillus pumulis, Trichoderma harzianum, Hirsutella rhossiliensis, Hirsutella minnesotensis, Verticillium chlamydosporum, and Arthrobotrys dactyloides;
other insecticidal compounds and nematicidal compounds: fipronil, ethiprole, sulfoxaflor, flupyradifurone, beta-cyfluthrin, tefluthrin, chlorpyrifos, abamectin, spirotetramat, and fluensulfone;
azole compounds: azaconazole, bitertanol, bromuconazole, cyproconazole, difenoconazole, diniconazole, epoxyconazole, fenbuconazole, fluquinconazole, flusilazole, flutriafol, hexaconazole, imibenconazole, ipconazole, metconazole, myclobutanil, penconazole, propiconazole, prothioconazole, simeconazole, tebuconazole, tetraconazole, triadimenol, triticonazole, fenarimol, nuarimol, pyrifenox, imazalil, oxpoconazole-fumarate, pefurazoate, prochloraz, and triflumizole;
strobilurin compounds: kresoxim-methyl, azoxystrobin, trifloxystrobin, fluoxastrobin, picoxystrobin, pyraclostrobin, dimoxystrobin, pyribencarb, metominostrobin, orysastrobin, and N-methyl-2-[2-(2,5-dimethylphenoxyl)methyl]phenyl-2-methoxy-acetamide (racemic or enantiomer, containing a mixture of R-enantiomer and S-enantiomer (optional ratio));
metalaxyl compounds: metalaxyl and metalaxyl-M;
SDHI compounds: sedaxane, penflufen, carboxin, boscalid, furametpyr, flutolanil, fluxapyroxad, isopyrazam, fluopyram, and thifluzamide;
other fungicidal compounds: tolclophos-methyl, thiram, Captan, carbendazim, thiophanate-methyl, mancozeb, thiabendazole, isotianil, triazoxide, (RS)-2-methoxy-N-methyl-2-[α-(2,5-xylyloxy)-o-tolyl]acetamide, fludioxonil, ethaboxam, 3-chloro-5-phenyl-6-methyl-4-(2,6-difluorophenyl)pyridazine, 3-cyano-5-phenyl-6-methyl-4-(2,6-difluorophenyl)pyridazine, and N-(1,1,3-trimethylindan-4-yl)-1-methyl-3-difluoromethylpyrazole-4-carboxylic acid amide (racemic or enantiomer, containing a mixture of R-enantiomer and S-enantiomer (optional ratio)); and
plant growth regulators: ethephon, chlormequat-chloride, mepiquat-chloride, and 4-oxo-4-(2-phenylethyl)aminobutyric acid.

5. The control method according to claim 1, the method comprising the step of treating the crop field with the PPO-inhibiting compound before the crop seeds are sowed or vegetative organs such as tubers, bulbs, or stem fragments are planted.

6. The control method according to claim 1, the method comprising the step of treating the crop field with the PPO-inhibiting compound at the same time of sowing the crop seeds or plating of vegetative organs such as tubers, bulbs, or stem fragments.

7. The control method according to claim 1, the method comprising the step of treating the crop field with the PPO-inhibiting compound after the crop seeds are sowed or vegetative organs such as tubers, bulbs, or stem fragments are planted.

8. The control method according to claim 1, wherein the crop is wheat, barley, rye, triticale, oat, rice, sorghum, peanut, pulses except for soybean and peanut, sugar beet, rapeseed, sunflower, potato, sugar cane, or vegetables.

9. The control method according to claim 2, wherein one or more compounds selected from the compound group A is one or more compounds selected from the compound group A-1;
Compound group A-1:
neonicotinoid compounds: clothianidin, thiamethoxam, imidacloprid, dinotefuran, nitenpyram, acetamiprid, and thiacloprid;
diamide compounds: flubendiamide, chlorantraniliprole, cyantraniliprole, and a compound represented by the formula (II): 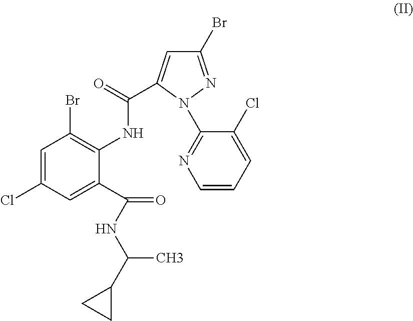 [SMILES: CC(NC(=O)c1cc(Cl)cc(Br)c1NC(=O)c1cc(Br)nn1-c1ncccc1Cl)C1CC1]
carbamate compounds: aldicarb, oxamyl, thiodicarb, carbofuran, carbosulfan, and dimethoate;
organic phosphorous compounds: fenamiphos, imicyafos, fensulfothion, terbufos, fosthiazate, phosphocarb, dichlofenthion, isamidofos, isazophos, ethoprophos, cadusafos, chlorpyrifos, heterofos, mecarphon, phorate, thionazin, triazophos, diamidafos, fosthietan, and phosphamidon;
biological nematicidal compounds: Harpin Protein, Pasteuria nishizawae, Pasteuria penetrans, Myrothecium verrucaria, Burkholderia cepacia, Bacillus chitonosporus, Paecilomyces lilacinus, Bacillus amyloliquefaciens, Bacillus firmus, Bacillus subtillis, Bacillus pumulis, Trichoderma harzianum, Hirsutella rhossiliensis, Hirsutella minnesotensis, Verticillium chlamydosporum, and Arthrobotrys dactyloides;
other insecticidal compounds and nematicidal compounds: fipronil, ethiprole, sulfoxaflor, flupyradifurone, beta-cyfluthrin, tefluthrin, chlorpyrifos, abamectin, spirotetramat, and fluensulfone;
azole compounds: azaconazole, bitertanol, bromuconazole, cyproconazole, difenoconazole, diniconazole, epoxyconazole, fenbuconazole, fluquinconazole, flusilazole, flutriafol, hexaconazole, imibenconazole, ipconazole, metconazole, myclobutanil, penconazole, propiconazole, prothioconazole, simeconazole, tebuconazole, tetraconazole, triadimenol, triticonazole, fenarimol, nuarimol, pyrifenox, imazalil, oxpoconazole-fumarate, pefurazoate, prochloraz, and triflumizole;
strobilurin compounds: kresoxim-methyl, azoxystrobin, trifloxystrobin, fluoxastrobin, picoxystrobin, pyraclostrobin, dimoxystrobin, pyribencarb, metominostrobin, orysastrobin, and N-methyl-2-[2-(2,5-dimethylphenoxyl)methyl]phenyl-2-methoxy-acetamide (racemic or enantiomer, containing a mixture of R-enantiomer and S-enantiomer (optional ratio));
metalaxyl compounds: metalaxyl and metalaxyl-M;
SDHI compounds: sedaxane, penflufen, carboxin, boscalid, furametpyr, flutolanil, fluxapyroxad, isopyrazam, fluopyram, and thifluzamide;
other fungicidal compounds: tolclophos-methyl, thiram, Captan, carbendazim, thiophanate-methyl, mancozeb, thiabendazole, isotianil, triazoxide, (RS)-2-methoxy-N-methyl-2-[α-(2,5-xylyloxy)-o-tolyl]acetamide, fludioxonil, ethaboxam, 3-chloro-5-phenyl-6-methyl-4-(2,6-difluorophenyl)pyridazine, 3-cyano-5-phenyl-6-methyl-4-(2,6-difluorophenyl)pyridazine, and N-(1,1,3-trimethylindan-4-yl)-1-methyl-3-difluoromethylpyrazole-4-carboxylic acid amide (racemic or enantiomer, containing a mixture of R-enantiomer and S-enantiomer (optional ratio)); and
plant growth regulators: ethephon, chlormequat-chloride, mepiquat-chloride, and 4-oxo-4-(2-phenylethyl)aminobutyric acid.

10. The control method according to claim 3, wherein one or more compounds selected from the compound group A is one or more compounds selected from the compound group A-1;
Compound group A-1:
neonicotinoid compounds: clothianidin, thiamethoxam, imidacloprid, dinotefuran, nitenpyram, acetamiprid, and thiacloprid;
diamide compounds: flubendiamide, chlorantraniliprole, cyantraniliprole, and a compound represented by the formula (II): 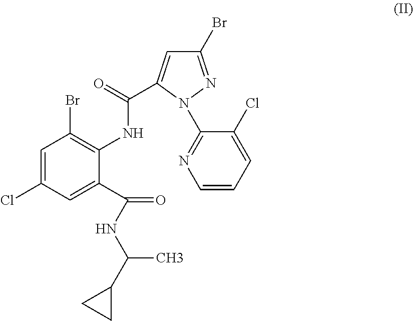 [SMILES: CC(NC(=O)c1cc(Cl)cc(Br)c1NC(=O)c1cc(Br)nn1-c1ncccc1Cl)C1CC1]
carbamate compounds: aldicarb, oxamyl, thiodicarb, carbofuran, carbosulfan, and dimethoate;
organic phosphorous compounds: fenamiphos, imicyafos, fensulfothion, terbufos, fosthiazate, phosphocarb, dichlofenthion, isamidofos, isazophos, ethoprophos, cadusafos, chlorpyrifos, heterofos, mecarphon, phorate, thionazin, triazophos, diamidafos, fosthietan, and phosphamidon;
biological nematicidal compounds: Harpin Protein, Pasteuria nishizawae, Pasteuria penetrans, Myrothecium verrucaria, Burkholderia cepacia, Bacillus chitonosporus, Paecilomyces lilacinus, Bacillus amyloliquefaciens, Bacillus firmus, Bacillus subtillis, Bacillus pumulis, Trichoderma harzianum, Hirsutella rhossiliensis, Hirsutella minnesotensis, Verticillium chlamydosporum, and Arthrobotrys dactyloides;
other insecticidal compounds and nematicidal compounds: fipronil, ethiprole, sulfoxaflor, flupyradifurone, beta-cyfluthrin, tefluthrin, chlorpyrifos, abamectin, spirotetramat, and fluensulfone;
azole compounds: azaconazole, bitertanol, bromuconazole, cyproconazole, difenoconazole, diniconazole, epoxyconazole, fenbuconazole, fluquinconazole, flusilazole, flutriafol, hexaconazole, imibenconazole, ipconazole, metconazole, myclobutanil, penconazole, propiconazole, prothioconazole, simeconazole, tebuconazole, tetraconazole, triadimenol, triticonazole, fenarimol, nuarimol, pyrifenox, imazalil, oxpoconazole-fumarate, pefurazoate, prochloraz, and triflumizole;
strobilurin compounds: kresoxim-methyl, azoxystrobin, trifloxystrobin, fluoxastrobin, picoxystrobin, pyraclostrobin, dimoxystrobin, pyribencarb, metominostrobin, orysastrobin, and N-methyl-2-[2-(2,5-dimethylphenoxyl)methyl]phenyl-2-methoxy-acetamide (racemic or enantiomer, containing a mixture of R-enantiomer and S-enantiomer (optional ratio));
metalaxyl compounds: metalaxyl and metalaxyl-M;
SDHI compounds: sedaxane, penflufen, carboxin, boscalid, furametpyr, flutolanil, fluxapyroxad, isopyrazam, fluopyram, and thifluzamide;
other fungicidal compounds: tolclophos-methyl, thiram, Captan, carbendazim, thiophanate-methyl, mancozeb, thiabendazole, isotianil, triazoxide, (RS)-2-methoxy-N-methyl-2-[α-(2,5-xylyloxy)-o-tolyl]acetamide, fludioxonil, ethaboxam, 3-chloro-5-phenyl-6-methyl-4-(2,6-difluorophenyl)pyridazine, 3-cyano-5-phenyl-6-methyl-4-(2,6-difluorophenyl)pyridazine, and N-(1,1,3-trimethylindan-4-yl)-1-methyl-3-difluoromethylpyrazole-4-carboxylic acid amide (racemic or enantiomer, containing a mixture of R-enantiomer and S-enantiomer (optional ratio)); and
plant growth regulators: ethephon, chlormequat-chloride, mepiquat-chloride, and 4-oxo-4-(2-phenylethyl)aminobutyric acid.

11. The control method according to claim 2, the method comprising the step of treating the crop field with the PPO-inhibiting compound before the crop seeds are sowed or vegetative organs such as tubers, bulbs, or stem fragments are planted.

12. The control method according to claim 3, the method comprising the step of treating the crop field with the PPO-inhibiting compound before the crop seeds are sowed or vegetative organs such as tubers, bulbs, or stem fragments are planted.

13. The control method according to claim 4, the method comprising the step of treating the crop field with the PPO-inhibiting compound before the crop seeds are sowed or vegetative organs such as tubers, bulbs, or stem fragments are planted.

14. The control method according to claim 2, the method comprising the step of treating the crop field with the PPO-inhibiting compound at the same time of sowing the crop seeds or plating of vegetative organs such as tubers, bulbs, or stem fragments.

15. The control method according to claim 3, the method comprising the step of treating the crop field with the PPO-inhibiting compound at the same time of sowing the crop seeds or plating of vegetative organs such as tubers, bulbs, or stem fragments.

16. The control method according to claim 4, the method comprising the step of treating the crop field with the PPO-inhibiting compound at the same time of sowing the crop seeds or plating of vegetative organs such as tubers, bulbs, or stem fragments.

17. The control method according to claim 2, the method comprising the step of treating the crop field with the PPO-inhibiting compound after the crop seeds are sowed or vegetative organs such as tubers, bulbs, or stem fragments are planted.

18. The control method according to claim 3, the method comprising the step of treating the crop field with the PPO-inhibiting compound after the crop seeds are sowed or vegetative organs such as tubers, bulbs, or stem fragments are planted.

19. The control method according to claim 4, the method comprising the step of treating the crop field with the PPO-inhibiting compound after the crop seeds are sowed or vegetative organs such as tubers, bulbs, or stem fragments are planted.

20. The control method according to claim 2, wherein the crop is wheat, barley, rye, triticale, oat, rice, sorghum, peanut, pulses except for soybean and peanut, sugar beet, rapeseed, sunflower, potato, sugar cane, or vegetables.
